(19) United States
(12) Patent Application Publication
(10) Pub. No.: US 2007/0098898 A1
(43) Pub. Date: May 3, 2007

(54) Method for applying surface ornamentation on material of shoes, bags or clothing

(76) Inventor: Chi-Kung Wu, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/265,446

(22) Filed: Nov. 2, 2005

(51) Int. Cl. B05D 5/00; B05D 3/02

(52) U.S. Cl. 427/256; 427/372.2

(57) ABSTRACT

A method for applying surface ornamentation on material of shoes, bags or clothing involves the steps of: providing a sample, putting liquid PU resin on the sample to form a specific pattern, drying the specific pattern and obtaining the specific pattern on the sample. The present invention provides a way to form the specific pattern without a mold, so that the pattern is not limited by the mold. Furthermore, the cost for forming a pattern is reduced.

### BACKGROUND OF THE INVENTION

1. Field of the Invention

The present invention relates to a method for applying surface ornamentation on material of shoes, bags or clothing, and more particularly to a method that can be easily performed and is not time consuming.

2. Description of the Related Art

Conventional methods for applying surface ornamentation on shoes, bags or clothing include 3D printing, 2D printing, machine embroidery or by ultrasonic plastic welding. A conventional material (70) decorate with a 2D printing is shown in FIG. 7. However, the conventional methods for applying ornamentation have the following disadvantages.

1. The ultrasonic plastic welding method is complex and requires a mold for the specific pattern, so the cost for an ultrasonic plastic welded product is high.

2. To make a pattern on a surface of an object, injection or printing are well-known methods. However, the methods both also require molds, so the cost cannot be reduced. Furthermore, the pattern is limited by the size of the mold, the procedure is complex, the pattern is monotone and variation is less. Therefore, injection or printing is not ideal for large size patterns.

3. Patterns made by machine embroidery require the use of a sewing machine; therefore, it is also not ideal for large size patterns. Furthermore, patterns made by machine embroidery will crape easily.

To overcome the shortcomings, the present invention provides a method for applying surface ornamentation on material of shoes, bags or clothing to obviate or mitigate the aforementioned problems.

### SUMMARY OF THE INVENTION

The primary objective of the present invention is to provide a method for applying surface ornamentation on material of shoes, bags or clothing that can be performed easily and is not time consuming.

To achieve the objective, a method for applying surface ornamentation on material of shoes, bags or clothing in accordance with the present invention includes the steps of: providing a sample, putting liquid PU resin on the sample to form a specific pattern, and drying the specific pattern. The present invention provides a way to form a specific pattern without a mold, so that the size of the pattern is not limited by the mold. Furthermore, the cost of forming the pattern can be reduced.

Other objectives, advantages and novel features of the invention will become more apparent from the following detailed description when taken in conjunction with the accompanying drawings.

### BRIEF DESCRIPTION OF THE DRAWINGS

FIG. 1 is a flowchart of a method for applying surface ornamentation on material of shoes, bags or clothing in accordance with the present invention;

FIG. 2 is a perspective view of a first embodiment of an object of a method for applying surface ornamentation on material of shoes, bags or clothing in accordance with the present invention;

FIG. 3 is a cross-sectional view of the object during the procedure of a method for applying surface ornamentation on material of shoes, bags or clothing in FIG. 2;

FIG. 4 is a perspective view of an object during the procedure of a method for applying surface ornamentation on material of shoes, bags or clothing in FIG. 2;

FIG. 5 is a perspective view of a second embodiment of an object of a method for applying surface ornamentation on material of shoes, bags or clothing in accordance with the present invention;

FIG. 6 a perspective view of a third embodiment of an object of a method for applying surface ornamentation on material of shoes, bags or clothing in accordance with the present invention; and

FIG. 7 is perspective view of an object of a conventional method for applying surface ornamentation on material of shoes, bags or clothing in accordance with the prior art.

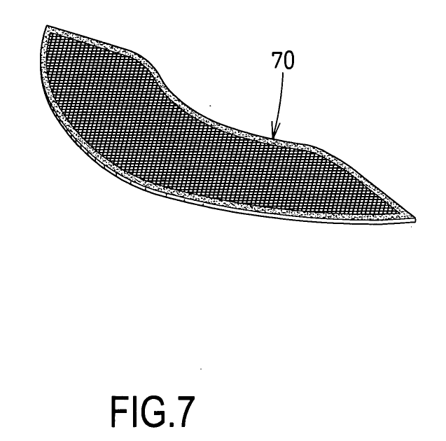

### DETAILED DESCRIPTION OF THE INVENTION

The present invention is related to a method for applying surface ornamentation on material of shoes, bags or clothing. The method disclosed in the present invention comprises putting a specific ornamentation or design on a surface of an object using a liquid PU resin. Preferably, the specific ornamentation or design is a relief pattern. Preferably, the liquid PU resin is a dense liquid PU resin, and the dense liquid PU resin may directly form a relief pattern after drying.

The term “sample” as used herein refers to, but is not limited to, cloth (such as cotton, gunny, synthetics or nylon), leather (such as artificial leather or natural leather), or fittings (such as metal).

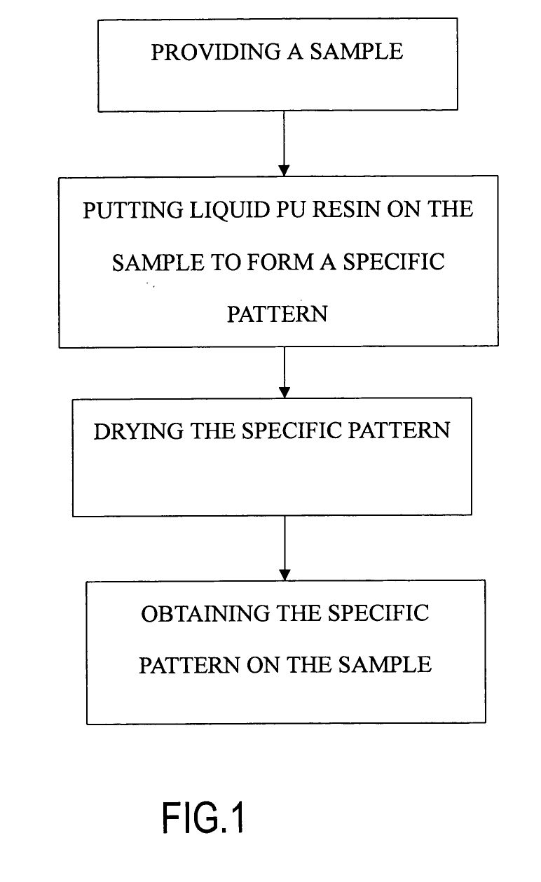

With reference to FIG. 1, the method for applying surface ornamentation on material of shoes, bags or clothing comprises preparing an outline of a design, then applying a liquid PU resin on the outline to form a relief pattern. Preferably, the outline is on or is a part of a surface of an object. More preferably, the object is a shoe, bag or clothing. Preferably, there are different colored PU resins used. After putting the liquid PU resin on the outline to form a relief pattern, the relief pattern is dried. In a preferred embodiment, the relief pattern is dried at room temperature. Finally, the specific relief pattern on the surface of an object is obtained.

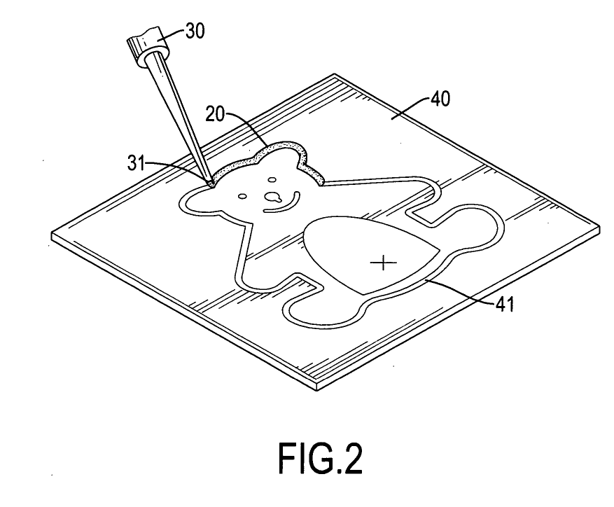

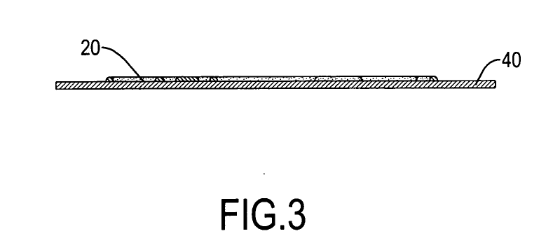

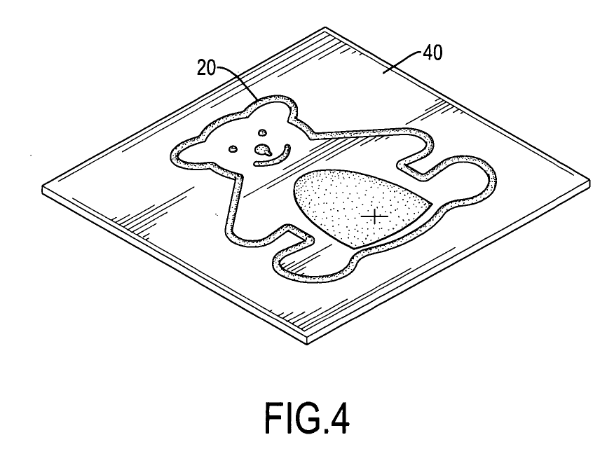

With reference to FIGS. 2 to 4, the liquid PU resin (20) used in the present invention is stored inside a container (30). The container (30) has an outlet (31) for the liquid PU resin (20) to be released. In a preferred embodiment, the container (30) may be a syringe. When the specific relief pattern is made, the outlet (31) is put toward a sample (40) with an outline to form the pattern. In a preferred embodiment, the container (30) with the outlet (31) is mounted on a manipulator, so the pattern may be directly formed by computer control.

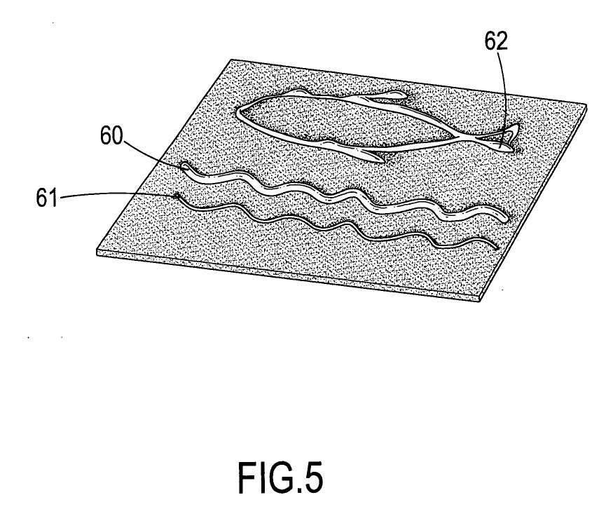

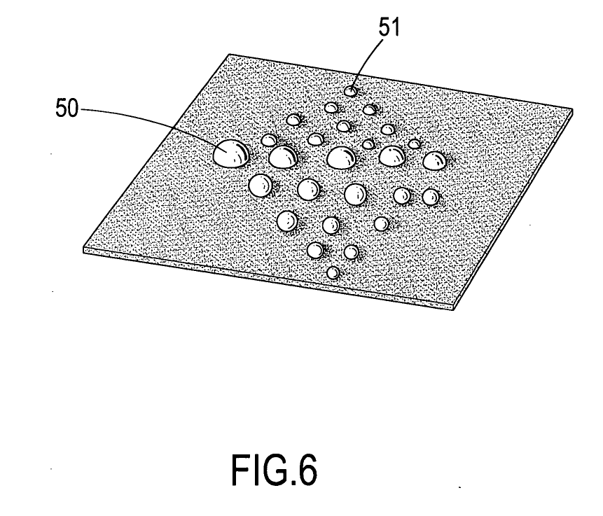

With reference to FIGS. 5 to 6, according to the method describes in the present invention, a pattern may form in various types, such as a big relief granule (50), a small relief granule (51), a thick line (60), a thin line (61) or a protruding spot (62). The pattern formed just depends on what a creator wants.

The method for surface ornamentation for material of shoes, bags or cloth has the following advantages.

1. The method provides a way to form a pattern directly on an object without the need of a mold; therefore, the cost for making a specific mold is eliminated.

2. The pattern is not limited by the mold, so various pattern can be created.

3. The dense liquid PU resin can be dried at room temperature and then cut or sewn, so the procedure to is simple.

4. The user may use different sizes of outlets in the container to create different visional effects.

5. Furthermore, the method disclosed in the present invention is ideal for a DIY user.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for applying surface ornamentation on material of shoes, bags or clothing comprising
providing a sample,
putting liquid PU resin on the sample to form a specific pattern,
drying the specific pattern, and
obtaining the specific pattern on the sample.

2. The method for applying surface ornamentation on material of shoes, bags or clothing as claimed in claim 1, wherein the sample is selected from a group consisting of cloth, leather and metal.

3. The method for applying surface ornamentation on material of shoes, bags or clothing as claimed in claim 2, wherein drying temperature for the drying step is room temperature.

4. The method for applying surface ornamentation on material of shoes, bags or clothing as claimed in claim 1, wherein the liquid PU resin is a dense liquid PU resin.

5. The method for applying surface ornamentation on material of shoes, bags or clothing as claimed in claim 1, wherein the sample comprises an outline of a design formed on the sample.

6. The method for applying surface ornamentation on material of shoes, bags or clothing as claimed in claim 1, wherein the specific pattern is a relief pattern.
